(19) United States
(12) Patent Application Publication
(10) Pub. No.: US 2007/0063456 A1
(43) Pub. Date: Mar. 22, 2007

(54) Apparatus for clamping work pieces

(75) Inventor: Ferdinand Troxler, Schenkon (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: F-Tool International AG, Oberdorfstrasse 6 (CH)

(21) Appl. No.: 11/507,336

(22) Filed: Aug. 21, 2006

(30) Foreign Application Priority Data
Sep. 21, 2005 (CH) 01536/05

(51) Int. Cl. B23B 31/02

(52) U.S. Cl. 279/156; 269/309

(57) ABSTRACT

The clamping apparatus provides for a positionally accurate clamping of a work piece having at least one shaft with a polygonal cross section. To this end, the clamping apparatus is provided with a clamping body member, having a clamping chamber with polygonal cross section adapted to receive the shaft of the work piece. The clamping body member is provided with clamping means to clampingly fix the shaft to the clamping body member, and with reference surfaces for determining the position of the work piece in X- and Y-directions. The reference surfaces are constituted by stop pin members inserted into bores provided in the clamping body member, whereby the stop pin members are made of a material that is harder than the material of the clamping body member. The stop pin members are of cylindrical shape, whereby the bores receiving the stop pin members open into the clamping chambers such that a small portion of each stop pin member protrudes into the interior of the clamping chamber.

### BACKGROUND OF THE INVENTION

The present invention refers to a clamping apparatus for clampingly retaining a work piece having a shaft with polygonal cross section in a well defined position. It comprises a clamping body member with a clamping chamber adapted to receive the shaft of the work piece, clamping means for clampingly retaining the shaft of the work piece in the clamping chamber, and reference surface means provided on the clamping body member for defining the position of the shaft clampingly retained in the clamping chamber in X-direction and/or in Y-direction.

Clamping apparatuses of the kind referred to herein serve for clampingly retaining work pieces in a well defined position, preferably in the operating region of a machine tool, whereby the expression “work piece” is used in its broadest meaning; in other words, besides conventional work pieces, that expression shall cover also for example machining tools.

### PRIOR ART

The document EP-A-0,248,116 discloses an apparatus for clamping non-rotating work pieces which have a shaft or a portion with a polygonal cross section. The apparatus comprises a clamping body member, provided with a clamping chamber having also a polygonal cross section. This clamping chamber serves for receiving the afore mentioned shaft or portion of the work piece. The clamping chamber is provided with three reference surfaces, serving for exactly aligning the work piece both in Y- and X-directions as well as with regard to its angular orientation around the Z-axis. For fixing the work piece, a clamping screw is provided, adapted to engage a chamfered thrust portion of the above mentioned shaft or portion of the work piece, in order to press the shaft or the portion of the work piece against the three reference surfaces. Even if this apparatus is rigid and stable and provides for a high repetitional accuracy, its production is very time consuming and costly.

### OBJECTS OF THE INVENTION

It is an object of the present invention to provide a clamping apparatus for clampingly retaining a work piece having a polygonal shaft in a positionally well defined manner that can be manufactured easily, quickly and particularly at very low costs without affecting the positional accuracy of clamping of the work piece to be clampingly retained in the apparatus to a noteworthy degree.

### SUMMARY OF THE INVENTION

In order to meet this and other objects, the present invention provides a clamping apparatus for clampingly retaining a work piece having a shaft with polygonal cross section in a well defined position. The apparatus comprises a clamping body member with a clamping chamber adapted to receive the shaft of the work piece, clamping means for clampingly retaining the shaft of the work piece in the clamping chamber, and reference surface means provided on the clamping body member for defining the position of the shaft clampingly retained in the clamping chamber in X-direction and/or in Y-direction.

The reference surface means comprises stop pin members provided in the clamping body member, whereby the stop pin members consist of a material that is harder than the material the clamping body member consists of.

Thus, one of the fundamental ideas of the invention is to manufacture the clamping body member of a base material that can be machined quickly, easily and, thereby, a low costs, while the few elements required for an accurate positioning in X- and/or Y-directions are made of a substantially harder material.

Preferably, the stop pin members are of cylindrical shape; thus, commercially available already finished round blanks can be used for manufacturing the stop pin members. A further advantage of cylindrical stop pin members may be seen in the fact that a work piece having flat lateral surfaces rests on the stop pin members along a line only, thus providing a high degree of immunity against contamination.

### BRIEF DESCRIPTION OF THE DRAWINGS

In the following, embodiments of the apparatus according to the invention will be further described, with reference to the accompanying drawings, in which:

FIG. 1 shows a perspective, partially sectioned view of a schematically illustrated first embodiment of a clamping apparatus;

FIG. 2 shows a top view of the clamping apparatus of FIG. 1;

FIG. 3 shows a longitudinal sectional view of the clamping apparatus, taken along the line A-A in FIG. 2;

FIG. 4 shows a perspective view of a schematically illustrated second embodiment of a clamping apparatus; and

FIG. 5 shows a perspective view of a schematically illustrated third embodiment of a clamping apparatus.

### DETAILED DESCRIPTION OF A PREFERRED EMBODIMENT

FIG. 1 shows a perspective, partially sectioned view of a clamping apparatus 1 for clampingly retaining a work piece 27, illustrated as an example, in the present case for instance an electrode for electro erosive machining. The schematically illustrated clamping apparatus 1 comprises a clamping body member 2 attached to a base plate 4 by means of screws 3. The base plate 4 is provided with a draw bar 5 by means of which it can be clampingly fixed to a clamping chuck (not shown). Moreover, the base plate 4 is provided with support pins 6 as well as with (not shown) centering and positioning elements, by means of which an accurate alignment of the base plate 4, and thereby also of the clamping body member 2, with regard to the clamping chuck of the machine tool is ensured.

A clamping chamber 8 is provided in the interior of the clamping body member 2, having a polygonal cross section. In the present example, the cross section of the clamping chamber 8 is substantially square. The clamping chamber 8 serves for receiving the work piece 27 which has a portion or shaft 28 with a cross sectional shape corresponding to the cross sectional shape of the clamping chamber 28. The front portion of the work piece 27 is designated by reference numeral 29. The work piece 27 is provided with a chamfered edge 30 adapted to be engaged by a clamping mechanism 10 of the clamping apparatus 1. In the region of three corners of the clamping chamber 8, free spaces in the form of recesses 9a, 9b, 9c are machined into the clamping body member 2. These recesses 9a, 9b, 9c ensure that the work piece 27 to be clampingly retained in the clamping apparatus 1 rests on the interior walls of the clamping chamber 8 with its lateral surfaces of its shaft 28 only and not with its edge portions. In the region of the fourth edge of the clamping chamber 8, the clamping mechanism 10 is located, as will be further explained herein after.

Along the one interior wall 11 of the clamping chamber 8, two bores 13, 14 are provided in the clamping body member 2, extending in Z-direction. Along the adjacent interior wall 12, located opposite to the clamping mechanism 10, a further bore 15 is provided in the clamping body member 2, extending in Z-direction as well. The position of these bores 13, 14, 15 refers to a reference point or a reference system, which is determined, in the present example, by the centering elements located on the base plate 4. These bores 13, 14, 15 are located within the clamping body member 2 such that they are open to the clamping chamber 8 along a strip-shaped portion. Inserted in each of these three bores 13, 14, 15 is a stop pin member 16, 17, 18, made of a material that is harder than the material of which the clamping body member 2 is made. For example, the clamping body member can be made of aluminum, while the stop pin members 16, 17, 18 are made preferably of hardened steel. Such stop pin members 16, 17, 18 are commercially available at a reasonably low price.

Each of the stop pin members 16, 17, 18 is inserted into and fixed in the assigned bore 13, 14, 15 by means of a press fit. Thereby, the stop pin members 16, 17, 18 protrude with a fraction of their diameter into the clamping chamber 8. The bores 13, 14, 15 as well as the stop pin members 16, 17, 18 preferably extend through the clamping body member 2 into the base plate 4; thereby, the position of the stop pin members 16, 17, 18 is well defined not only with regard to the clamping body member 2, but also with regard to the base plate 4 provided with the centering elements.

In the region of the forth corner of the clamping chamber 8, located on the bisecting line of the angle between the two interior walls 11, 12 provided with the stop pin members, the clamping mechanism 10 is situated. The clamping mechanism 10 comprises a thrust plate 20 in the form of a clamping jaw which can be moved forth and back by means of a set screw 21. For this purpose, the end of the set screw 21 is provided with a turntable-like protrusion in the form of a T-shaped end portion 22, rotatably engaging a corresponding recess of the thrust plate 20. The direction of action of the thrust plate 20 is chosen such that a work piece 27 received in the clamping chamber 8 is pressed against the reference surfaces constituted by the three stop pin members 16, 17, 18 upon tightening the set screw 21. It is understood that, instead of providing three stop pin members 16, 17, 18, for example four stop pin members could be provided; in such a case, the interior wall 12 of the clamping chamber opposite to the clamping mechanism 10 would be provided with two stop pin members.

Since the stop pin members 16, 17, 18 are of cylindrical shape, the reference surface is constituted by a line contact area between the stop pin members 16, 17, 18 and the flat lateral surfaces of the shaft 28 of the work piece 27. These line contact areas are shown in the drawing by means of dash-dotted lines 16a, 17a, 18a. As soon as the shaft 28 of the work piece 27 rests on the three stop pin members 16, 17, 18, the work piece is positioned in X- and Y-directions as well as with regard to its angular position around the Z-axis. Instead of the clamping mechanism shown in the drawings, it is possible to provide two clamping mechanisms offset to each other by 90°, one being located opposite to the lateral wall 11 provided with two stop pin members 16, 17, and the other one being located opposite to the lateral wall 12 provided with one stop pin member 18.

Preferably, the shaft 28 of the work piece 27 is provided with a chamfered edge portion 30 to be engaged by the thrust plate 20 in non-positive or, if appropriate in positive manner. By means of this chamfered portion 30, also the correct angular orientation of the shaft 28 with regard to the clamping body member is determined; in other words, the shaft 28 cannot be inserted into the clamping body member 2 in a position rotated by 90°, 180° or 270° with regard to the correct orientation.

The bottom of the clamping chamber 8 is provided with a screw 25 serving as a Z-direction stop member. This screw 25 is screwed into a bore running through the base plate 4 and provided with a corresponding female thread. For exactly determining the height of the screw 25 above the bottom of the clamping chamber 8, i.e. for exactly determining the Z-reference position, the head of the screw 25 at the bottom of the clamping chamber 8 is ground down to the desired height.

Furthermore, the clamping body member 2 is provided with a ball thrust screw 23 for loosely fixing a work piece received in the clamping chamber 8.

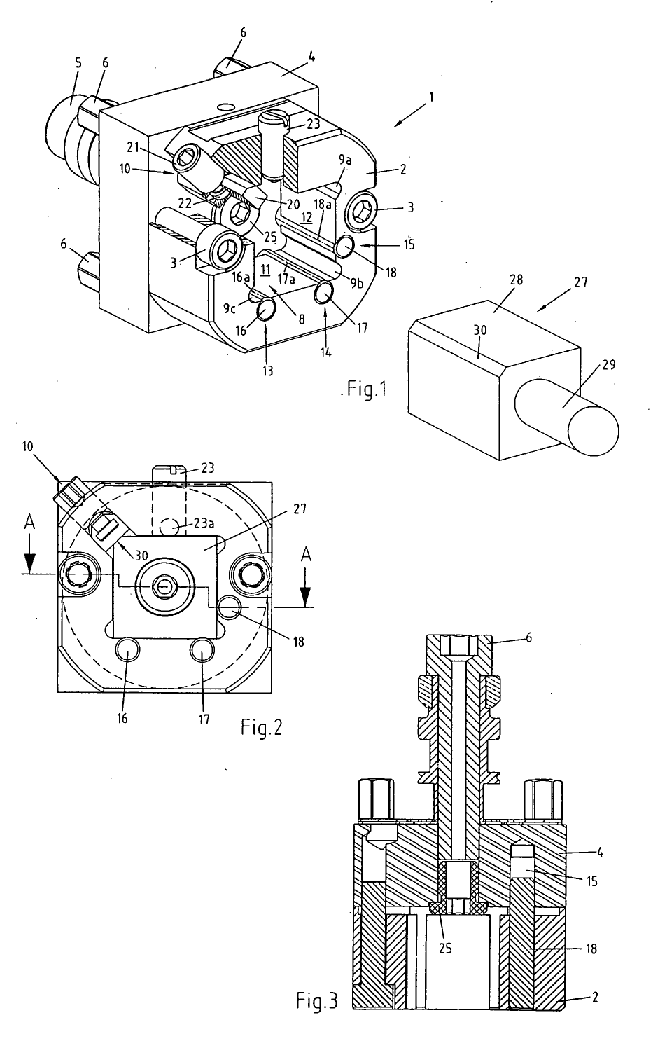

FIG. 2 shows a top view of the clamping apparatus according to FIG. 1, however without being partially sectioned. Particularly well visible in this illustration is the clamping mechanism 10, by means of which the schematically shown work piece 27 is pressed on its chamfered region 30 against the reference surfaces constituted by the three stop pin members 16, 17, 18. The work piece 27 received in the clamping chamber 8 is secured against falling out by means of the ball thrust screw 23. The ball thrust screw 23 is located opposite to the lateral wall 11 provided with two stop pin members 16, 17. By means of the force exerted by the ball thrust screw 23 and its ball 23a, respectively, on the work piece 27, it is additionally ensured that the work piece 27 is pressed against the stop pin members 16, 17 protruding from the lateral wall 11 of the clamping chamber 8.

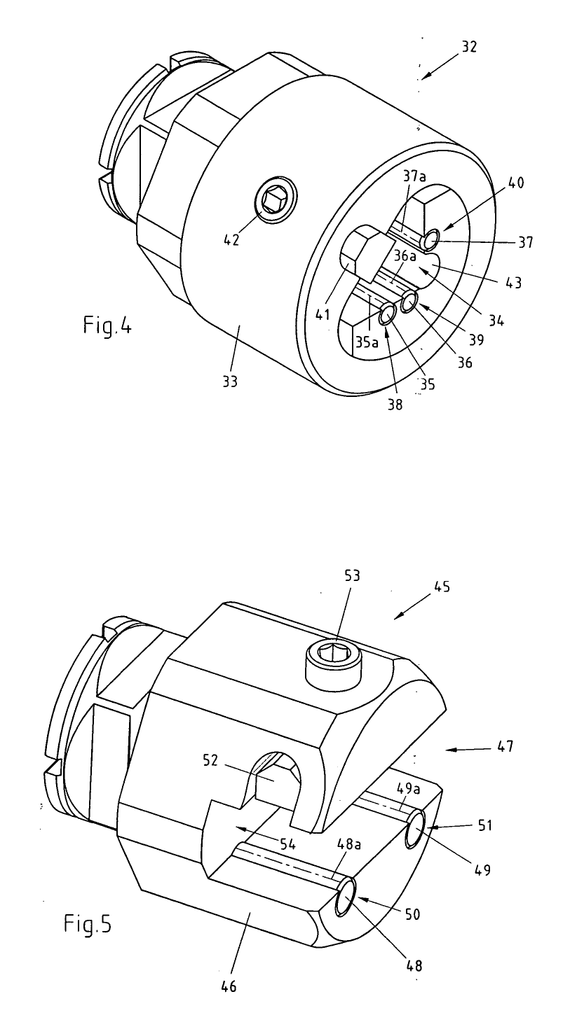

FIG. 3 shows a longitudinal sectional view of the clamping apparatus of FIG. 1 along the line A-A in FIG. 2. Besides the clearly visible draw bar 5, this illustration shows particularly well that the bore 15 adapted to receive the stop pin member 18 extends up to and into the base plate 4, and that the stop pin member 18 is anchored both in the clamping body member 2 as well as in the base plate 4. Furthermore, the screw 25, serving as a Z-axis stop member and screwed into a female threaded bore in the base plate 4, is clearly visible. Due to the fact that the stop pin members 16, 17, 18 are anchored both in the clamping body member 2 and in the base plate 4, on the one hand, an accurate positioning of the stop pin members 16, 17, 18 with regard to the base plate 4 is ensured, and on the other hand, the relatively soft clamping body member 2 is accurately positioned with regard to the base plate 4 and rigidly fixed thereon.

FIG. 4 shows a perspective view of another embodiment of a clamping apparatus 32. In this case, the clamping body member 33 is provided with a clamping chamber 34 which has, as seen in a cross sectional view, the shape of a right angle triangle. The clamping chamber 34 of this embodiment is particularly well adapted to clampingly retain work pieces having shafts with triangular or square cross sections. Along a first lateral wall, two stop pin members 35, 36 are provided, while a second, adjacent lateral wall, extending perpendicular to said first lateral wall, is provided with a stop pin member 37. For clamping the work piece and the shaft of the work piece, respectively, again a thrust plate 41 in the form of a clamping jaw is provided, located diametrically opposite to a recess 43 situated in the corner between the two lateral walls extending perpendicular to each other. The thrust plate 41 is arranged in such a way that a shaft received in the clamping chamber 34 is pressed against the two lateral walls provided with the stop pin members 35, 36, 37, with the result that the position of the work piece is accurately determined in X- and Y-directions. For moving the thrust plate 41 back and forth, a set screw 42 is provided. The line contact areas 35a, 36a, 37a of the stop pin members 35, 36, 37 again are shown in the drawing by dash-dotted lines.

FIG. 5 shows a perspective view of a further embodiment of a clamping apparatus 45. The clamping body member 46 is, in this example, provided with a clamping chamber 47 in the form of a continuous elongate slot. A first wall laterally delimiting the clamping chamber 47 is provided with two stop pin members 48, 49, while the second wall laterally delimiting the clamping chamber 47 is provided with a clamping jaw 52 substantially extending along this lateral wall. In this case, the bottom 54 of the clamping chamber 47 serves as a Z-axis stop member for the work piece and its shaft, respectively. For operating the clamping jaw 52, again a set screw 53 is provided. The line contact areas 48a, 49a of the stop pin members 48, 49 are illustrated as well. With such a clamping apparatus 45, even very long elongate work pieces and shafts, respectively, can be clampingly fixed, whereby the position of the particular work piece is determined by the two stop pin members 48, 49 only along one axis, particularly in X-direction or in Y-direction.

Instead of the embodiments shown in the drawings, in which the clamping body member is attached to a base plate, and in which the base plate comprises centering elements and a draw bar, it is possible to attach the clamping body member for example to an arbitrary base plate or a similar element which, in turn, is provided with a defined reference point. In some cases, it may even be sufficient to provide the clamping body member itself with one or several reference elements, such that the clamping body member can be attached to an arbitrary base body member in a well defined position. Finally, also multiple clamping apparatuses could be realized, in which a number of clamping body members are attached to a common base plate.

Due to the fact that the clamping body member 2 is made of a inexpensive, relatively light and easily to machine base material, and further that it is provided with stop pin members 16, 17, 18 constituting the reference surfaces 16a, 17a, 18a and made of a material that is substantially harder than the material of the clamping body member 2, the clamping apparatus of the invention can be manufactured quickly, easily and at low costs. By providing cylindrical sop pin members, 16, 17, 18 as reference surfaces, a line contact between work piece and stop pin members is ensured; this has a positive effect as far as the immunity against contamination is concerned. With a clamping apparatus according to the invention, both work pieces and machinining tools can be clampingly fixed in a well defined position, with high repetitional accuracy, in the proper orientation and also in a reference oriented manner.

What is claimed is:

1. A clamping apparatus for clampingly retaining a work piece having a shaft with polygonal cross section in a well defined position, comprising:
A clamping body member with a clamping chamber adapted to receive said shaft of said work piece;
Clamping means for clampingly retaining said shaft of said work piece in said clamping chamber; and
Reference surface means provided on said clamping body member for defining the position of said shaft clampingly retained in said clamping chamber in X-direction and/or in Y-direction;
Said reference surface means comprising stop pin members provided in said clamping body member, said stop pin members consisting of a material that is harder than the material the clamping body member consists of.

2. A clamping apparatus according to claim 1 in which said clamping body member is provided with bores located adjacent to said clamping chamber provided in said clamping body member and adapted to receive said stop pin members in such a way that a portion of each stop pin member protrudes into the interior of said clamping chamber.

3. A clamping apparatus according to claim 2 in which said stop pin members have cylindrical shape.

4. A clamping apparatus according to clam 2 in which said clamping chamber has a polygonal cross section and is provided with at least three bores adapted to receive each one of said stop pin members, whereby two of said bores are located along a first lateral wall of said clamping chamber, and whereby at least one further bore is located along a second lateral wall of said clamping chamber that is adjacent to said first lateral wall.

5. A clamping apparatus according to claim 2 in which said clamping chamber has a slot-like configuration and comprises two lateral walls delimiting the clamping chamber, whereby at least two bores adapted to receive said stop pin members are provided along a first of said lateral walls, and whereby the other lateral wall opposite to said first lateral wall is adapted to receive said clamping means for clampingly retain said shaft of said work piece.

6. A clamping apparatus according to claim 2 in which said bores extend in Z-direction and are parallel to each other.

7. A clamping apparatus according to claim 2 in which said stop pin members are fixed in said bores by means of a press fit.

8. A clamping apparatus according to claim 2 in which said bores are open towards said clamping chamber along a strip-shaped portion extending in Z-direction.

9. A clamping apparatus according to claim 2 in which said clamping body member is attached to a base plate member, whereby said bores extend through said clamping body member into said base plate member and whereby said stop pin members are fixed both to said clamping body member and said base plate member.

10. A clamping apparatus according to claim 9 in which said base plate member is provided with at least one attaching means for attaching said clamping apparatus to a chuck means.

11. A clamping apparatus according to claim 10 in which said attaching means comprises a draw bar.

12. A clamping apparatus according to claim 9 in which said base plate member is provided with positioning elements adapted to accurately align said base plate member with regard to a chuck member.

13. A clamping apparatus according to claim 1 in which the bottom of said clamping chamber comprises a reference surface portion adapted to serve as a Z-direction stop member.

14. A clamping apparatus according to claim 13 in which said reference surface portion comprises a reference element attached to the bottom of said clamping chamber.

15. A clamping apparatus according to claim 1 in which said clamping chamber essentially has the shape of a right angle triangle, as seen in a horizontal cross sectional view.

16. A clamping apparatus according to claim 10 in which said base plate member is provided with positioning elements adapted to accurately align said base plate member with regard to a chuck member.
